(19) United States
(12) Patent Application Publication
(10) Pub. No.: US 2016/0210088 A1
(43) Pub. Date: Jul. 21, 2016

(54) NESTING METHOD AND APPARATUS

(71) Applicant: AGFA GRAPHICS NV, Mortsel (BE)

(72) Inventor: Kurt VAN DEN BRANDEN, Mortsel (BE)

(21) Appl. No.: 14/912,614

(22) PCT Filed: Aug. 18, 2014
(86) PCT No.: PCT/EP2014/067556

§ 371 Date: Feb. 18, 2016

(30) Foreign Application Priority Data
Aug. 30, 2013 (EP) 13182368.4

(51) Int. Cl. G06F 3/12

(52) U.S. Cl. CPC G06F 3/125; G06F 3/1204; G06F 3/1219; G06F 3/1243

(57) ABSTRACT

A processing apparatus performs a nesting method by solving partial overlap in content extension areas of print jobs after nesting. The nesting method replaces the content extension areas of nested print jobs which have a partial overlap with new content extension areas to reduce substrate waste and enhance the production timings.

### CROSS-REFERENCE TO RELATED APPLICATIONS

This application is a 371 National Stage Application of PCT/EP2014/067556, filed Aug. 18, 2014. This application claims the benefit of European Application No. 13182368.4, filed Aug. 30, 2013, which is incorporated by reference herein in its entirety.

### BACKGROUND OF THE INVENTION

1. Field of the Invention

This invention relates to printing of nested print jobs for example on a sheet of a substrate printed by a wide-format printer that need to be finished for example on a table cutter or manufactured to a three-dimensional object. The invention relates in particular in a nesting method, such as true shape nesting, wherein the content extension areas, such as bleed areas, are replaced when content extension areas of nested print jobs are partial overlapping each other.

2. Description of the Related Art

A processing apparatus which executes nesting processing is done by software which implements a computerized nesting method. Such software is mainly called nesting software. The nesting method consists in the arrangement of the content in print jobs on a digital printer's sheet of a substrate to reduce substrate waste. To achieve this, a digital printed sheet must be filled as fully as possible.

Nesting refers to the process of efficiently manufacturing parts from flat raw material. Companies manufacturing parts from flat raw material such as sheet metal use a variety of technologies to perform this task. The sheet metal nesting for flat sheets and nesting for coils are different algorithms. Material may be cut using off-line blanking dies, lasers, plasma, punches, shear blades, ultrasonic knives and even water jet cutters. In order to minimize the amount of scrap raw material produced by this process, companies use nesting software. The software analyses the shapes of the parts to be produced at a particular time. Using proprietary nesting methods, it then determines how to lay these parts out in such a way as to produce the required quantities of parts, while minimizing the amount of raw material wasted.

It is known that such nesting methods are used in the wide-format printing industry to achieve that a digital printed sheet is being filled with print jobs as fully as possible to reduce substrate waste and production timings. Known suppliers of software that are using said nesting methods are Caldera® with “Visual Cut”, ErgoSoft® with “PosterPrint”.

An example of a nesting method and nesting software is disclosed in JP2007058617 (SEIKO EPSON CORP) wherein print jobs are nested by an image data generation device and a previewing method of the nested print jobs on a display and the generation of the image date to be output in an arrangement state as accepted by an user.

Each print job may be associated with an area enclosed by a boundary of the content of the print job. This boundary defines the size, shape and dimensions of the content in a print job after finishing (e.g. cutting, manufacturing to a three-dimensional object (1201, 1202, 1301), folding to a three dimensional object). This area is called the content area.

A print job may also be associated with a second area enclosed by a second boundary which overlaps totally the content area. This area is created e.g. to compensate inaccuracies in the printing process and/or finishing process (e.g. cutting, folding, manufacturing to a three dimensional object, folding to a three dimensional object). This second area is called the content extension area. Another less used name for content extension area is offset cut area. This second area is mostly created by expanding the present content area of the print job with several millimetres (e.g. from 2 or 5 mm). The size of expanding the content area to a content extension area depends on the inaccuracies of the printing process and/or finishing process (e.g. cutting, folding, manufacturing to a three dimensional object, folding to a three dimensional object).

While nesting the print jobs the content areas are not positioned with partial overlap but the content extension areas of two print jobs may partially overlap after using a nesting method on the digital printer's sheet so the printing process could not print one of the print jobs to the associated content extension area of the print job. It would therefore be advantageous to have a nesting method that can solve partial overlap of content extension areas of print jobs after arranging the print jobs on one or more printer's sheet or printer's web.

### SUMMARY OF THE INVENTION

There has been room for improvement in the prior art for nesting content of print jobs wherein the content extension areas partial overlaps. This improvement makes it possible to solve erroneous nested print jobs, wherein the content extension areas partial overlaps, still to produce by printing and finishing. It is also a method to improve automatic nesting methods to reduce substrate waste and enhance the production timings of print jobs when the automatic nesting method is based on the content area of the print jobs and not on the content extension area because the method solves partial overlap of content extension areas between print jobs.

A preferred embodiment of the nesting method, performed by a processing apparatus, comprising the steps of

obtaining a first and second print job wherein the first print job has a first content area (CT1) (12), defined by a first content path and a first content extension area (CTE1) (11), defined by a first content extension path and wherein the second print job has a second content area (CT2) (22), defined by a second content path and a second content extension area (CTE2) (21), defined by a second content extension path and wherein the first content extension area (CTE1) (11) has a partial overlap with the second content extension area (CTE2) (21); and

determining a first intersection area (J) (50) between

(i) the first content extension area (CTE1) (11) minus the second content extension area (CTE2) plus the first content area (CT1) (12) and;
(ii) the first content extension area (CTE1) (11) minus the second content area (CT2) (22) plus the first content area (CT1) (12);

and replacing the first content extension area (CTE1) (11) with a third content extension area (CTE3) (31) and the second content extension area (CTE2) (21) with a fourth content extension area (CTE4) (41); and characterized that

the ratio between (A) the surface of the first intersection area (J) (50); and the sum of (B) the surface of the intersection of the third content extension area (CTE3) (31) and the first intersection area; and (C) the surface of the intersection of the fourth content extension area (CTE4) (41) and the first intersection area (J) (50) is between 90% and 110%; and

the ratio between (B) the surface of the intersection of the third content extension area (CTE3) (31) and the first intersection area (J) (50) and (A) the surface of the first intersection area (J) (50) is larger than 5% and smaller than 95%.

The replacing of the first content extension area (CTE1) (11) and second content extension area (CTE2) (21) is replaced by content extension area means, also called a content extension area replacer, which is comprised in the processing apparatus that performs a preferred embodiment of the nesting method.

A preferred embodiment replaces the content extension area of the first print job and the second print job so both print jobs have still a content extension area and the overlap between the first and second content extension areas became smaller to make it possible to print the nested print jobs.

A preferred embodiment of the nesting method, performed by a processing apparatus with determining means, comprising the following steps:

determining a third content extension path that defines the third content extension area (CTE3) (31); and

determining a fourth content extension path that defines the fourth content extension area (CTE4) (41); and

wherein the step of replacing the first content extension area (CTE1) (11) with the third content extension area (CTE3) (31) and the second content extension area (CTE2) (21) with the fourth content extension area (CTE4) (41) is characterized that

a segment (60) of the third content extension path is in common with a part of the fourth content extension path; and

the segment (60) is part of the first intersection area (J) (50).

The segment (60) is created by segment creation means, also called a segment creator, which is comprised in the processing apparatus that performs a preferred embodiment of the nesting method.

A preferred embodiment of the previous preferred embodiments wherein a content extension path and/or content path is used, comprises an extra step of simplifying the content extension path and/or content path, more preferably the simplifying is done by an iterative end-point fit algorithm. After the content extension path and/or content path is simplified the content extension area and/or content area may preferably be calculated.

A preferred embodiment of the previous embodiments comprises the following steps:

determining the minimum content extension path of the first print job that defines the area from first content extension area (CTE1) (11) minus the second content extension area (CTE2) (21) plus the first content area (CT1) (12); and

determining the maximum content extension path of the first print job that defines the area from the first content extension area (CTE1) (11) minus the second area content area (CT2) plus the first content area (CT1) (12);

and wherein the replacing of the first content extension area (CTE1) (11) with the third content extension area (CTE3) (31) and the second content extension area (CTE2) (21) with the fourth content extension area (CTE4) (41) is characterized that:

the segment (60) has a start point that is in common with the minimum content extension path of the first print job and the maximum content extension path of the first print job and/or the segment (60) has an end point that is in common with the minimum content extension path of the first print job and the maximum content extension path of the first print job.

A preferred embodiment is a method of true shape nesting, performed by true shape nesting apparatus which comprises all previous preferred embodiments.

A preferred embodiment of the nesting method, performed by a processing apparatus (82), wherein the step of obtaining the first and second print job is characterized by obtaining the print jobs wherein the first content area (CT1) (12) and the second content area (CT2) (22) are disjunctive areas.

If three or more obtained print jobs have a content extension area partly in common (overlap) than the method may be performed on the first obtained print job and the second obtained print job. The method may be repeated on the first obtained print job with its replaced content extension area (CTE3) and the following obtained print job, which is not the second obtained print job, or may be repeated on the second obtained print job with its replaced content extension area (CTE4) and the following obtained print job, which is not the first obtained print job.

Another preferred embodiment of the nesting method if three obtained print jobs have a content extension area partly in common (overlap) than the method is performed on the first obtained print job and the second obtained print job to a new first temporary content extension area for the first print job and the method is performed on the first obtained print job and the third obtained print job, to a new second temporary content extension area for the first print job. The replaced content extension area of the first print job is the overlap of the first temporary content extension area and the second temporary content extension area.

The content extension area (CTE1) and/or content extension area (CTE2) is preferably a bleed area.

Preferably R2 defined by formula (III) is in a preferred embodiment of the nesting, performed by a processing apparatus (82), method larger than 25% and smaller than 75%, more preferably R2 is larger than 40% and smaller than 60% and most preferably R2 is larger than 45% and smaller than 55%. By making the ranges of R2 smaller a preferred embodiment of the nesting method shall become more optimized for finishing the nested print jobs.

Preferably R1 defined by formula (II) is in a preferred embodiment of the nesting method, performed by a processing apparatus (82), in the range from 95% until 105%, more preferably R1 is in the range from 90% until 100% and most preferably in the range of 95% until 99.99%. If R1 is smaller or equal than 100% the overlap area as defined by formula (I) with instead of CTE1 the replaced content extension area CTE3 and instead of CTE2 the replaced content extension area CTE4, shall become empty which is a preferred embodiment. If there is still overlap with the replaced content extension areas (CTE3, CTE4) the rastering of the nested print jobs shall preferably clip (=not printing) the overlapping parts of the replaced extension areas (CTE3, CTE4).

A preferred embodiment of the nesting method, performed by a processing apparatus (82), may

remove image data in the area defined as the first content extension area (CTE1) (11) minus the third content extension area (CTE3) (31); and/or

remove image data in the area defined as the second content extension area minus the fourth content extension area (CTE4) (41).

A preferred embodiment of the nesting method, performed by a processing apparatus (82), may comprise an extra step:

creation of a content area and/or content path of the first print job before the obtaining step. The created content area and/or content path may overrule the existing content area and/or content path of the first print job.

A preferred embodiment of the nesting method, performed by a processing apparatus (82) may comprise an extra step:

creation of a content extension area and/or content extension path of the first print job before the obtaining step or after the creation of a content area and/or content path of the first print job as in the previous preferred embodiment. The created content extension area and/or content extension path may overrule the existing content extension area and/or content extension path of the first print job.

A more preferred embodiment has an extra step after the step of the creation of a content extension area and/or content extension path wherein rastered pixels of the first print job, positioned on the content path of the print job or at the boundary of the content area of the print job, are cloned by a pixel cloner in the area that is defined by the content extension area of the print job minus the content area of the print job (FIG. 25, FIG. 26).

The processing apparatus (82) that performs a preferred embodiment of the nesting method may be comprised in a digital printer, preferably a wide-format printer, to print the nested print jobs and/or a cutting device, preferably a table cutter, to finish the nested print jobs.

A preferred embodiment of the nesting method comprises an extra step:

Enlarging the content extension area while simplifying a content extension path of the first print job. The enlarging of the content extension area is preferred because the content of the content extension area is less important after finishing. The enlarging of the content extension area while simplifying a content extension path is preferable done by an enlarge surface optimized closed path simplifying method.

A preferred embodiment of the nesting method comprises an extra step:

Shrinking of a content area while simplifying the content path of the first print job. The shrinking of the content area is preferred because the content of the content area is more important than outside the content area after finishing. The shrinking of the content area while simplifying a content path is preferable done by a shrink surface optimized closed path simplifying method. After shrinking the content area of a print job while simplifying the content path of the first print job, a preferred embodiment of the nesting method may create a content extension area of the print job and/or content extension path of the first print job.

A preferred embodiment of this previous preferred embodiment comprises simplifying of the minimum content extension path and/or maximum content extension path of the first print job. Preferably the simplifying is done by reducing the number of 2D-points in the path and more preferably it is done by an iterative end-point fit algorithm.

The area that is defined by a minimum content extension path is called the minimum content extension area (111).

The area that is defined by a maximum content extension path is called the maximum content extension area (112).

### BRIEF DESCRIPTION OF THE DRAWINGS

FIG. 1 illustrates an example of a print job (90) with as content a police car created in a content area (902) and a content extension area (901) to compensate inaccuracies of cutting as finishing process.

FIG. 2 illustrates an example of a print job (91) with as content a hatchback car created in a content area (902) and a content extension area (901) to compensate inaccuracies of cutting as finishing process.

FIG. 3 illustrates an example of a print job (92) with as content a three-box sedan car created in a content area (902) and a content extension area (901) to compensate inaccuracies of cutting as finishing process.

FIG. 4 illustrates a nesting queue (81) of 3 selected print jobs (90, 91, 92) which are nested in a processing apparatus (82) that performs a rectangular nesting method to arrange several copies of content of the print jobs on a digital printer's sheet (830) of a substrate to reduce substrate waste.

FIG. 5 illustrates a nesting queue (81) of 3 selected print jobs (90, 91, 92) which are nested in a processing apparatus (82) that performs a true shape nesting method to arrange several copies of content of the print jobs on a digital printer's sheet (831) of a substrate to reduce substrate waste. The amount of copies of content of the print jobs is higher than the nesting method that is used in FIG. 4.

FIG. 6 illustrates two content areas (12,22) of two print jobs with their content extension area (11,21) wherein the content extension areas (11,21) overlaps each other.

FIG. 7 illustrates two content areas (12,22) of two print jobs with their content extension area (11,21) wherein the content extension areas (11,21) overlaps each other in the intersection area (50).

FIG. 8 illustrates two content areas (12,22) of two print jobs with their content extension area (21) wherein the minimum content extension area (111) of the left print job (11) with content area (12) is marked.

FIG. 9 illustrates two content areas (12,22) of two print jobs with their content extension area (21) wherein the maximum content extension area (112) of the left print job (11) with content area (12) is marked.

FIG. 10 illustrates two content areas (12,22) of two print jobs with their content extension area (11,21) wherein the content extension areas (11,21) overlaps each other and the result of the segment creator to a segment (60) that divides the intersection area (50) in 2 parts.

FIG. 11 illustrates two content areas (12,22) of two print jobs with their replaced content extension areas (31, 41) and the result of the segment creator to a segment (60).

FIG. 12 illustrates two examples of three-dimensional finished product (1201, 1202) used as point-of-sale-displays which are manufactured by printed and cut print jobs on cardboard.

FIG. 13 illustrates another example of a three-dimensional finished product (1301) used as point-of-sale-display which is folded (1302) by a printed and cut print job (1303). The lock flaps, foot are content extension areas which are added to a print job to make the folding to a three-dimensional finished product (1201, 1202, 1301) possible and strong.

FIG. 14 illustrates a closed path (1402) that is defining a finite area (1401). The closed path (1402) is an example of an irregular closed path and irregular concave closed path.

FIG. 15 illustrates a closed path (1402) that is defining a finite area (1401). The closed path (1402) is an example of an irregular closed path and self-intersecting (1501) closed path.

FIG. 16 illustrates a closed path (1402) that is defining a finite area (1401). The closed path (1402) is an example of an irregular closed path, self-intersecting closed path and hole (1601) self-intersecting closed path.

FIG. 17 illustrates a closed path (1402) that is defining a finite area (1402).

FIG. 18 illustrates another closed path (1402) that is defining the same finite area (1402) as in FIG. 17 but the closed path (1402) is defined with less 2D-points as a result of a iterative end-point algorithm on the closed path of FIG. 17.

FIG. 19 illustrates the working of simplifying a closed path with an enlarge surface optimized closed path simplifying method on a closed path (1402), its finite area (1401) and its several 2D-points (1902, 1901, 1903, 1904) to a closed path wherein the 2D-points (1901, 1903) are removed and 2D-point (1905) is added.

FIG. 20 illustrates the working of simplifying a closed path with an enlarge surface optimized closed path simplifying method on a closed path (1402), its finite area (1401) and its several 2D-points (1902, 1901, 1903, 1904) to a closed path wherein 2D-point (1903) is removed.

FIG. 21 illustrates the working of simplifying a closed path with an enlarge surface optimized closed path simplifying method on a closed path (1402), its finite area (1401) and its several 2D-points (1902, 1901, 1903, 1904) to a closed path wherein 2D-point (1901) is removed.

FIG. 22 illustrates the working of simplifying a closed path with a shrink surface optimized closed path simplifying method on a closed path (1402), its finite area (1401) and its several 2D-points (1902, 1901, 1903, 1904) to a closed path wherein the 2D-points (1901, 1903) are removed and 2D-point (1905) is added.

FIG. 23 illustrates the working of simplifying a closed path with a shrink surface optimized closed path simplifying method on a closed path (1402), its finite area (1401) and its several 2D-points (1902, 1901, 1903, 1904) to a closed path wherein 2D-point (1903) is removed.

FIG. 24 illustrates the working of simplifying a closed path with a shrink surface optimized closed path simplifying method on a closed path (1402), its finite area (1401) and its several 2D-points (1902, 1901, 1903, 1904) to a closed path wherein 2D-point (1901) is removed.

FIG. 25 illustrates a print job with a circular content area (2501), circular content path (2503), circular content extension area (2502) and circular content extension path (2504). The content in the content area is a vignette from black to dark gray to light gray. Content at the boundary of the content area (2501) is cloned mirror-wise in the content extension area (2502) which is not part of the content area (2501). The content in the content extension area (2502) is a small vignette from light gray to dark gray at the boundary of the content extension area (2502).

FIG. 26 illustrates a print job with a circular content area (2501), circular content path (2503), circular content extension area (2502) and circular content extension path (2504). The content in the content area is a vignette from black to dark gray to light gray. Content at the boundary of the content area (2501) is cloned in the content extension area (2502) which is not part of the content area (2501). The content in the content extension area (2502) is light gray.

FIG. 27, FIG. 28 and FIG. 29 is an illustration of the approximation of a segment in the segment creator in an order of recursively steps. The segment (2701), with its start 2D-point and end 2D-point (2701, 2702), divides the intersection area (2705) in two parts with the isolated section from the minimum content extension path (2704) and the isolated section from the maximum content extension path (2708).

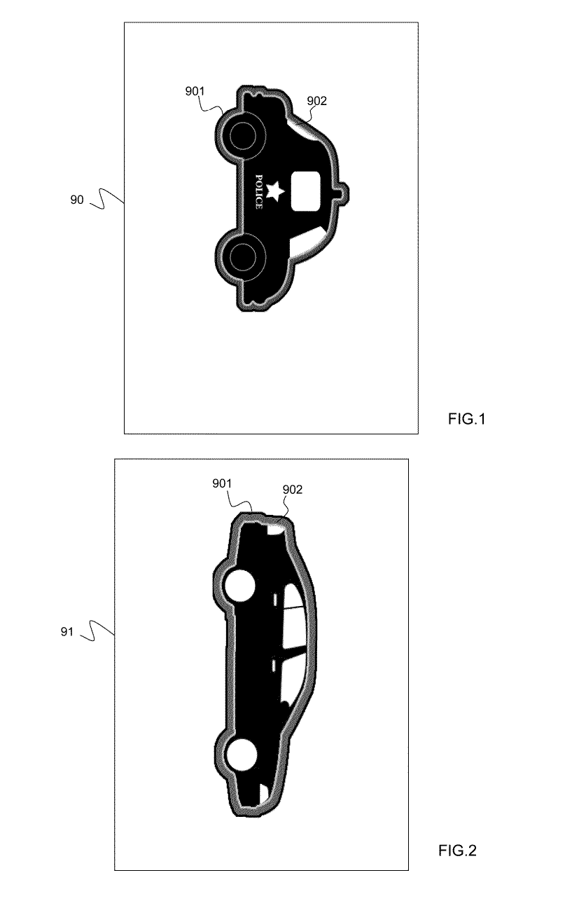

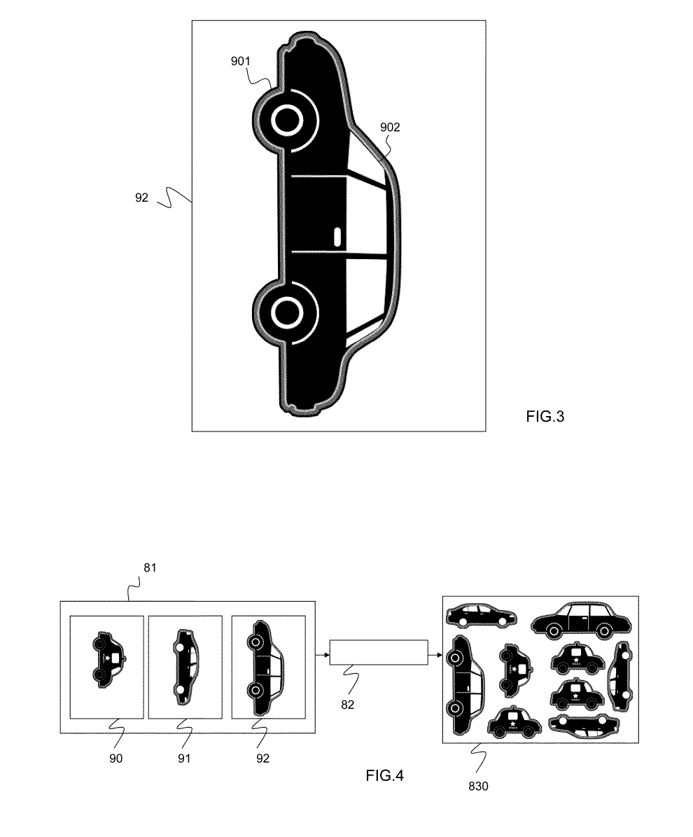

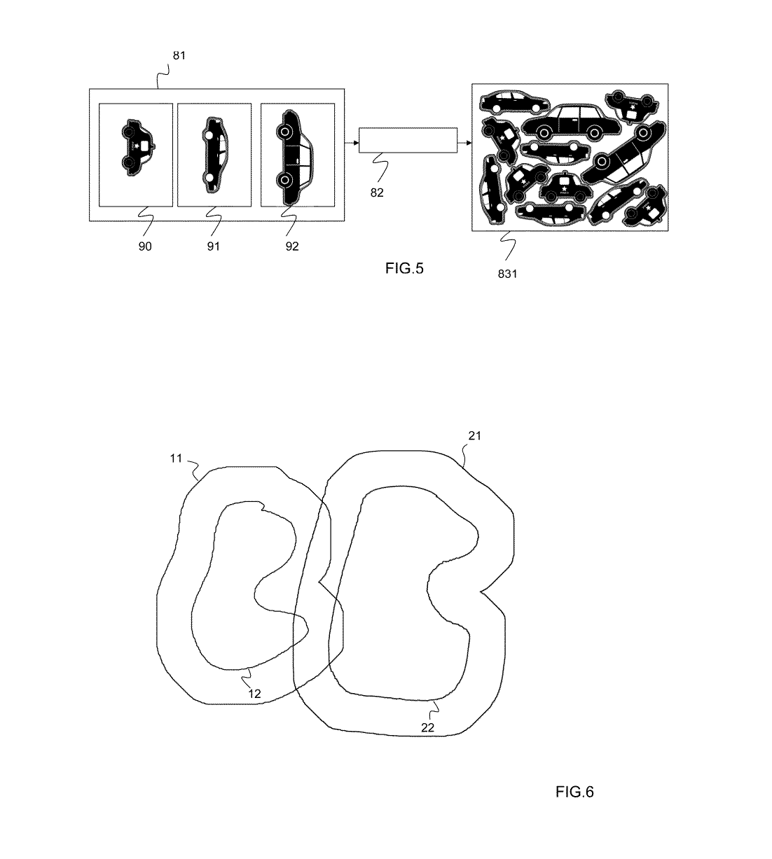

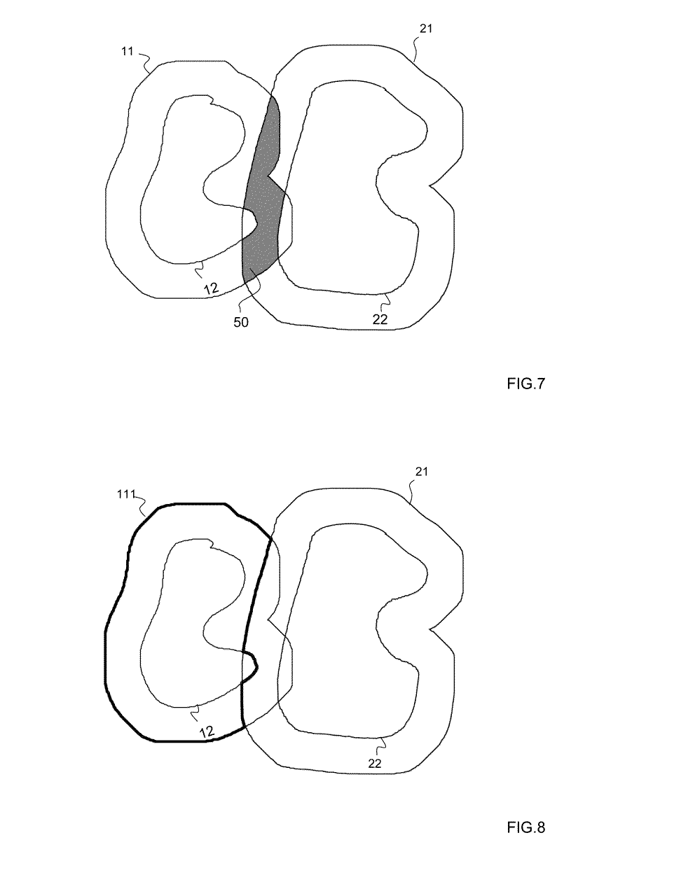

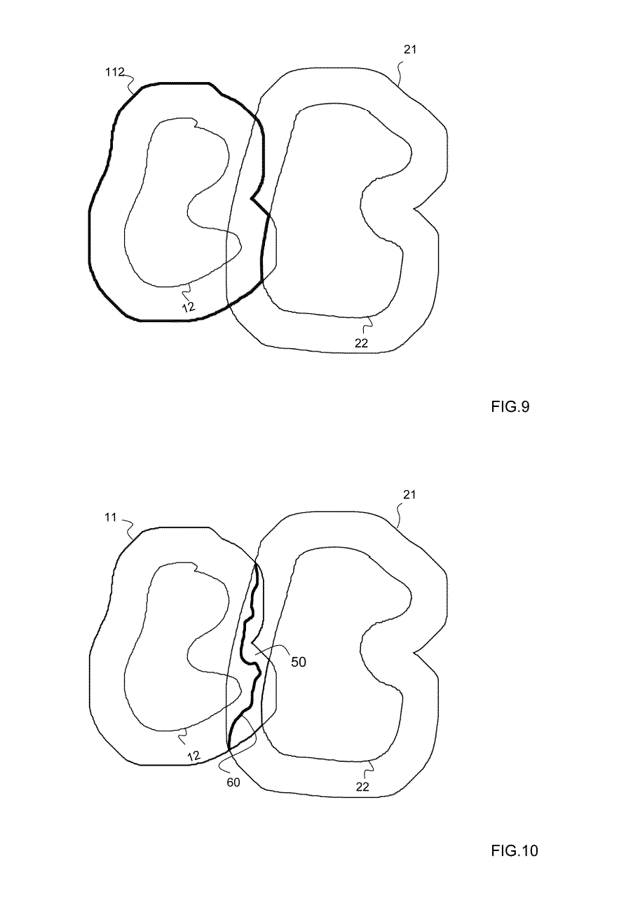

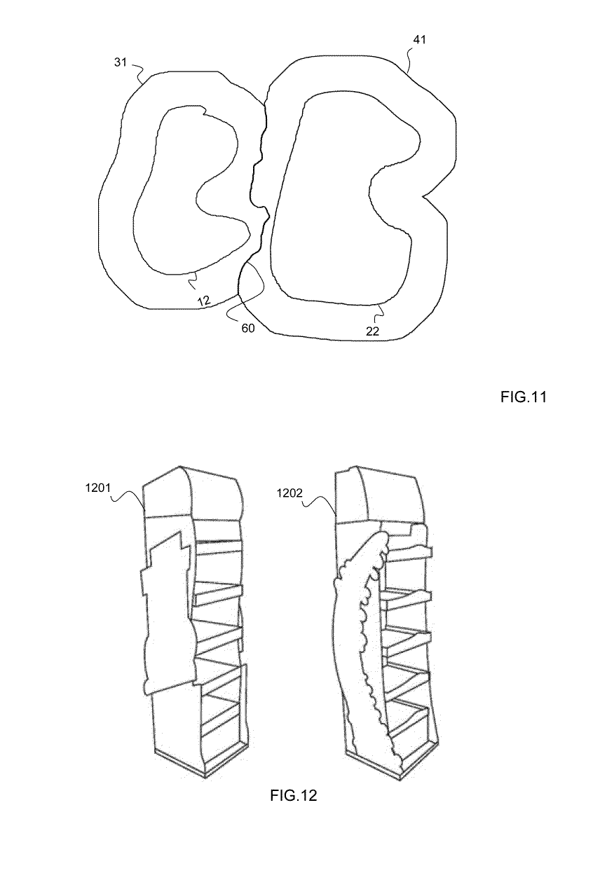

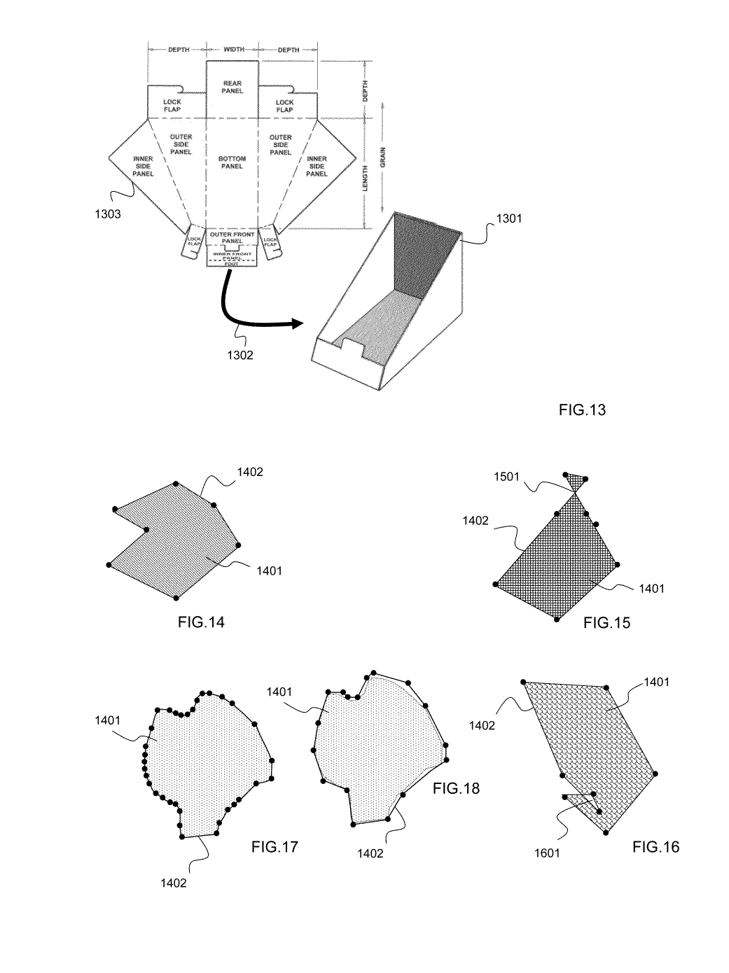

### DETAILED DESCRIPTION OF THE PREFERRED EMBODIMENTS

### Digital Printing Systems

Today, more and more digital printing systems are developed for the reproduction of images and/or text. Several digital printing technologies are used such as electro-photography, thermal transfer, dye sublimation and ink jet systems, three dimensional colour inkjet systems to name a few. In this document a digital printing system may be referred as digital printer.

An example of a digital printing system is disclosed in EP 2565778 A (BROTHER IND LTD) where the digital printer performs printing based on operation in a host connected to a USB-port and wherein a print processing method is executed by the digital printer.

Preferably a preferred embodiment of the nesting method may providing a method to transfer the nested print jobs on one or more sheets of substrate to print on a digital printer by appropriate means e.g. computer network or USB-port in a appropriate raster image format, vector image format or page description language such as PostScript (PS) or Page Description Format (PDF). More preferably a preferred embodiment of the nesting method may providing a method to transfer the nested print jobs on one or more sheets of substrate to print on a wide-format printer by appropriate means e.g. computer network or USB-port in a appropriate raster image format, vector image format or page description language such as PostScript (PS) or

### Page Description Format (PDF).

Preferably a preferred embodiment of the nesting method may providing a method to transfer the nested print jobs on a roll of substrate to print on a digital web printer by appropriate means e.g. computer network or USB-port in a appropriate raster image format, vector image format or page description language such as PostScript (PS) or Page Description Format (PDF).

### Wide-Format Printers

Wide-format printers are generally accepted to be any digital printer with a print width over 17″. Digital printers with a print width over the 100″ are also super-wide printers or grand format printers. Wide-format printers are mostly used to print banners, posters, textiles and general signage and in some cases may be more economical than short-run methods such as screen printing. Wide format printers generally use a roll of substrate rather than individual sheets of substrate but today also wide format printers exist with a table whereon substrate is loaded. Either the table moves under a print head array or a gantry moves a head array over the table. These so called flat-table digital printers most often are used for the printing of planar substrates or ridged substrates or sheets of flexible substrates. They may incorporate IR-dryers or UV-dryers to prevent prints from sticking to them as they are produced. An example of a wide-format printer and more specific a flat-table digital printer is disclosed in EP1881903 B (AGFA GRAPHICS NV). Several technologies for wide format printers are used. According the ink that is used in these wide format printers they can be categorized in:

Aqueous: thermal or Piezo inkjet printers using an ink known as aqueous or water-based. The term water base is a generally accepted misnomer. The pigment is held in a non-reactive carrier solution that is sometimes water and other times a substitute liquid, including a soy based. Aqueous ink generally comes in two flavours, Dye and UV (alternatively known as pigment). Dye ink is high colour, low UV-resistant variety that offers the widest colour gamut. UV ink is generally duller in colour but withstands fading from UV rays. Similar in general principle to desktop inkjet printers. Finished prints using dye inks must be laminated to protect them if they are to be used outdoors while prints using UV inks can be used outdoors un-laminated for a limited time. Various substrates are available, including canvases, banners, metabolized plastic and cloth. Aqueous technology requires that all substrates be properly coated to accept and hold the ink.

Solvent: this term is used to describe any ink that is not water-based. Piezo inkjet printers whose inks use petroleum or a petroleum by-product such as acetone as its carrier liquid. “Eco-solvent” inks usually contain glycol esters or glycol ether esters and are slower drying. The resulting prints are waterproof. May be used to print directly on uncoated vinyl and other substrates as well as ridged substrates such as Foam Board and PVC.

Dye sublimation: inks are diffused into the special substrates to produce continuous-tone prints of photographic quality.

UV: Piezo inkjet printers whose inks are UV-curable (dry when cured with UV light). The resulting prints are waterproof, embossed & vibrant. Any substrates to be print on can be used in this technology, polymer made substrates are best. Ceramics, glass, metals, and woods are also used to print on with these categorized wide format printers.

### Cutting Plotter

An example of a finishing apparatus is a cutting plotter that is well known to cut a desired shape out a sheet of a substrate. The most common cutting device is a digital finishing table, also called digital cutting table or table cutter. The digital cutting tables are mainly used in packaging industry and sign or display industry. The digital finishing table may have a vacuum table that holds the sheet of a substrate while finishing the sheet.

The cutting of the sheet is mainly done with sharp knifes but other technologies such as laser, water-jet, punches, shear blades, plasma cutting, ultrasonic knifes, rotary cutters (e.g. milling tools) and flame cutting can also be used.

By selecting the correct cutting tools and/or parameters, the substrate finishing apparatus may cut a broad range of substrates such as folding carton, acrylic plates, honeycomb, corrugated board, foam, medium density fibreboard, solid board, rigid paper board, fluted core board, plastics, aluminium composite material, foam board, corrugated plastic, carpet, textile, thin aluminium, paper, rubber, adhesives, vinyl, veneer, varnish blankets, wood, flexo plates, fibreglass and others. These substrates can be printed before the cutting by the cutting device with a wide-format printer.

An example of table cutter is disclosed in EP 2455184 A (MIMAKI ENGINEERING COMPANY) wherein a gantry moves over the bed in a first direction and a head with cutting tools is moving along the gantry in a second direction.

The cutting is achieved because the cutting device comprises means that use a method for sending the cutting shapes and dimensions to the cutting device in order to command the cutting tools to produce the correct finished print job.

The means for sending the cutting shapes and dimensions is preferably a computerized method that may be loaded in a memory of a computer, connected to the cutting device, and driven on the computer.

The content area and/or content extension area of a nested print job in a preferred embodiment of the nesting method may be converted to the sent cutting shapes and dimensions. Preferably the conversion to the sent cutting shapes and dimensions is from the content path and/or content path of a nested print job, more preferably it is from the replacing content extension area of a nested print job and most preferably it is from the replacing content extension path of a nested print job. The conversion to cutting shapes and dimensions may be a computerized method that may be loaded in a memory of a computer, connected to the cutting device, and driven on the computer. The conversion to cutting shapes and dimensions in a cutting device to command the cutting tools to produce the correct finished print job may be a computerized method that is comprised in a preferred embodiment of the nesting method.

Preferably a preferred embodiment of the nesting method may providing a method to transfer cutting shapes and dimensions to a cutting device in an appropriate format e.g. DXF or PDF by appropriate means e.g. network or USB-port. More preferably a preferred embodiment of the nesting method may providing a method to transfer content paths, content extension paths and/or replacing content extension paths to a cutting device by appropriate means e.g. computer network.

### Print Jobs

Print jobs (90, 91, 92) such as document pages, labels, business cards, photographic images and the like have been printed in the art using nesting to improve efficiency. The content of a print job is preferable defined in raster graphics format such as Portable Network Graphics (PNG), Tagged Image File Format (TIFF), Adobe Photoshop Document (PSD) or Joint Photographic Experts Group (JPEG) or bitmap (BMP) but more preferably in vector graphics format, also called line-work format, such as Scale Vector Graphics (SVG) and AutoCad Drawing Exchange Format (DXF) and most preferably a page description language (PDL) such as Postscript (PS) or Portable Document Format (PDF).

A print job may be stored and/or loaded as one or more files on a memory of a computer. A preferred embodiment of the nesting method may comprise a method to load a print job to a memory of a computer.

A print job may be a element of a queue of print jobs that is generated from Variable-data printing (VDP), also known as variable-information printing which is a form of digital printing, including on-demand printing, in which elements such as text, graphics and images may be changed from one printed piece to the next, without stopping or slowing down the printing process and using information from a database or external file. The generated print jobs from a variable-data printing method may be nested on one or more sheets of substrate.

In a preferred embodiment of the nesting method has a step of selecting print jobs that have to be arranged on one or more sheets of substrate. The selection is preferably done by adding the print jobs in a queue, also called the nesting queue (81). A preferred embodiment of the nesting method may provide a method to visualize the nesting queue and the arrangement of the selected print jobs on a sheet. Preferably the visualization is visualizing thumbnails of the content of the print jobs more preferably the visualization is visualizing information of the selected print jobs such as job name, creator name, amount of copies that need to be nested, preferred rotation.

### Content Area

From each selected print job, in a preferred embodiment of the nesting method, the content area (902) may be extracted from the print job but preferably the content area is created based on the content of the selected print job.

Due to the content of the print job a content area (CT1, CT2) in a preferred embodiment of the nesting method is preferably an irregular area and more preferably an irregular concave area. Due to the content of the print job a content path in a preferred embodiment of the nesting method is preferably an irregular closed path and more preferably an irregular concave closed path.

The creation of the content area is preferably done automatically in a preferred embodiment of the nesting method and it is preferably based on a tracing method, also called vectorization of the content to a closed path wherein the content is defined. The tracing method is preferably using an edge detection algorithm. The area in the closed path defines than the created content area. This closed path is called the content path.

The creation of the content area may be done by the operator of a preferred embodiment of the nesting method by drawing a contour around the content of a selected print job. A preferred embodiment of the nesting method may provide a method to draw manual a contour around the content by an operator. The area in the contour defines than the created content area. This manually defined contour is preferably transformed to a closed path by a tracing method, also called vectorization.

The extraction of a content area out a selected print job may be calculated from a bitmap mask that is part of the print job but preferably it is calculated from the content path which is associated with the print job and defined in the print job. The content path of a selected print job may be calculated from the content area as a closed path wherein the content area is defined.

The content area and/or content path may be defined in a layer of a layer capable content format such as PSD, TIFF, PS, SVG, DXF and PDF. The content area and/or content path may be defined in a spot colour channel of a spot colour channel capable content format such as PSD, TIFF, PS, SVG, DXF and PDF.

A preferred embodiment of the nesting method may transform the content area of the selected print job to a simplified content area by simplifying its content path first. The simplified content area is calculated from the simplified content path. This content area calculation maybe done by rastering the simplified content path. The simplifying of the content path is preferably done by reducing the number of 2D-points in the path and more preferably it is done by an iterative end-point fit algorithm and most preferably a shrink surface-optimized closed path simplified algorithm.

A preferred embodiment of the nesting method may transform the content area of the selected print job to an optimized content area based on the finishing process (e.g. cutting, folding, manufacturing to a three dimensional object, folding to a three dimensional object).

A preferred embodiment of the nesting method may raster the content of the print job to a bitmap format to the resolution and colour space of the digital printer when the content of the print job is defined in vector graphics or a page description language.

A preferred embodiment of the nesting method may provide a method to visualize the content, the content area and/or content path of a selected print job on a computer screen.

### Content Extension Area

To compensate inaccuracies in the printing process and/or finishing process and/or provide extension to a print job to mount the print job in e.g. three-dimensional object (1201, 1202, 1301), content extension areas (901) have to be designed in a print job before finishing the print job.

Examples of content extension areas are:

glue area: an area that will be mainly left unprinted and will be glued afterwards while mounting the print job to a finished product;

connect area: an area that will be mainly left unprinted and will be attached while mounting the print job to a finished product. E.g. The point-of-sale-displays are mostly mounted print jobs with connect areas to a three-dimensional finished product. They are normally covered with branding for the product they are trying to sell, and are made out of cardboard or foamboard, and/or a covering over a plastic or Perspex/Plexiglass stand, all intended to be easily replaceable and disposable. This allows designers to make full use of color and printing to make the display visually appealing;

folding area: an area that will be mainly left unprinted and will be folded and/or attached while mounting the print to a finished product. E.g. flaps that are needed to fold a print job to a box;

bleed area: Several finishing processes are used in the sign and display industry such as die cutting, kiss cutting, drill cutting, creasing, perforating, foil stamping, embossing, hi-die cutting, guillotine cutting, wet or dry laminating, V-cutting. These finishing processes may have inaccuracies while manipulating the printed print-job and that's why content extension areas may be needed.

Due to the content of the print job a content extension area (CTE1, CTE2) in a preferred embodiment of the nesting method is preferably an irregular area and more preferably an irregular concave area. Due to the content of the print job a content extension path in a preferred embodiment of the nesting method is preferably an irregular closed path and more preferably an irregular concave closed path.

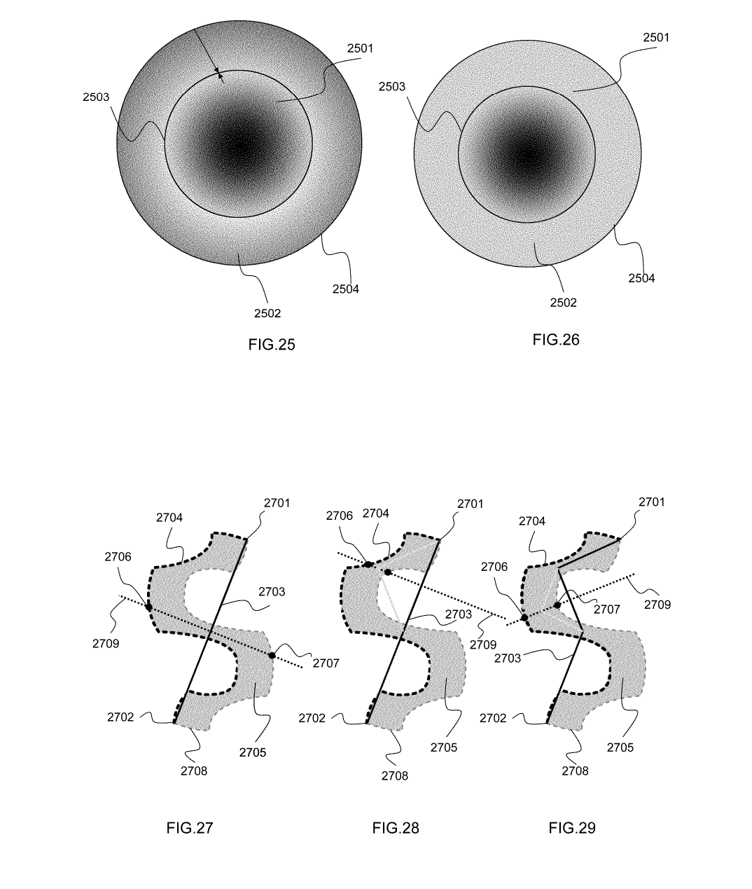

From each selected print job, in a preferred embodiment of the nesting method, the content extension area is extracted from the print job but preferably created based on the content area and/or content path of the selected print job. The content extension area overlaps totally the content area. In a preferred embodiment of the nesting method the content extension of a print job is created. Another preferred embodiment is that the area of the content extension area that is not part of the content area may be filled with empty content or one colour but preferably the area of the content extension area that is not part of the content area has the same content as the content at the boundary of the content area (FIG. 26) and more preferably the content of the content area at the boundary of the content area is mirrored in the area of the content extension area that is not part of the content area (FIG. 25). If the content area is defined by vector graphics or page description language, a preferred embodiment of the nesting method may raster the vector graphics or page description language to a bitmap format at or near the boundary of the content area and the area of the content extension area that is not part of the content area may be filled with the rastered content data at the boundary of the content area and more preferably the area of the content extension area that is not part of the content area may be filled with a mirrored rastered content data at the boundary of the content area.

The extraction of a content extension area out a selected print job may be calculated from a bitmap mask that is part of the print job but preferably it is calculated from the content extension path which is associated with the print job and defined in the print job.

The content extension path of a selected print job may be calculated from the content extension area as a closed path wherein the content extension area is defined.

The content extension area and/or content extension path may be defined in a layer of a layer capable content format such as PSD, TIFF, PS, SVG, DXF and PDF. The content extension area and/or content extension path may be defined in a spot colour channel of a spot colour channel capable content format such as PSD, TIFF, PS, SVG, DXF and PDF.

A preferred embodiment of the nesting method may transform the content extension area of the selected print job to a simplified content extension area by simplifying its content extension path first. The content extension area is calculated from the simplified content extension path. This content extension area calculation may be done by rastering the simplified content extension path. The simplifying of the content extension path is preferably done by reducing the number of 2D-points in the path and more preferably it is done by an iterative end-point fit algorithm or a split-and-merge algorithm and most preferably a surface-optimized closed path simplifying algorithm.

A preferred embodiment of the nesting method may provide a method to visualize the content extension area and/or content extension path of a selected print job on a computer screen.

### Bleed Area

A bleed area is an example of a content extension area that is created to compensate inaccuracies in the printing process and/or finishing process such as cutting and folding. Another less used name for bleed area is offset cut area. This bleed area is mostly created by expanding the present content area of the print job with several millimetres (e.g. from 2 or 5 mm). The size of expanding the content area to a bleed area depends on the inaccuracies of the printing process and/or finishing process (e.g. cutting).

The creation of a bleed area for a print job, which may be overruling the existing bleed area of a print job, is preferably done automatically in a preferred embodiment of the nesting method and preferably based on a method that is expanding the content area of the print job with a distance. This method is also called choking the content area.

This distance that expands the content area to create the bleed area is called bleed distance or choking distance. The bleed distance is preferably from 0.1 mm to 10 mm, more preferably from 1 mm to 8 mm and most preferably from 2 to 5 mm. The bleed distance may be selected in a preferred embodiment of the nesting method but it is more preferred to select the bleed distance automatically in a preferred embodiment of the nesting method based on the printing and/or finishing process. It is most preferred that the bleed distance is selected depending the content of the selected print job. The bleed distance may be different per print job.

The bleed area creation preferably creates a content extension area that has the same shape as the content area with the same centre as the content area but the shape is larger than the content area wherein the centre the point is in the content area with equal distances from all points on the boundary of the content area.

A preferred embodiment of the nesting method may transform the bleed area of the selected print job to an optimized bleed area based on the cutting process.

### Path

A path in a preferred embodiment of the nesting method, in a preferred embodiment of the nesting method, may be defined as a sequence of minimal two 2D-points which are connected with a sub-path. A sub-path may be a curve defined as a 2D-function between 2D-points such as a line, polygon, a Bezier curve or a parametric equation. It is not necessary that each sub-path is using the same 2D-function. A 2D-point is defined as a point with an x-coordinate and y-coordinate as used in a Cartesian coordinate system. A 2D-point of a path may be referred as a point. If a 2D-point is added the two new sub-paths that are constructed in the path may be defined as a curve, defined as a 2D-function between 2D-points such as a line, polygon, a Bezier curve or a parametric equation. It is not necessary that the two new sub-paths are using the same 2D-function as in the other sub-paths. If a 2D-point is removed the new sub-path between the previous 2D-point and the following 2D-point may be constructed based on the position of the removed 2D-point or more preferably defined as a 2D-function between 2D-points such as a line, polygon, a Bezier curve or a parametric equation.

Algorithms to determine the crossing of two paths are known in computer-aided design (CAD) or vector graphic drawing software such as Adobe® Illustrator.

Algorithms to convert a path defined in raster graphics format such as a manual drawing line or boundary of a finite area defined in a raster graphics to a path are known in computer-aided design (CAD) or vector graphic drawing software such as Adobe® Illustrator. These algorithms are sometimes called tracing or vectorization.

The conversion of a path defined in raster graphics format to a path is preferably done by tracing methods or boundary tracing methods.

The conversion of the boundary of a finite area defined in a raster graphics to a path is preferably done by a contour tracing method such as an edge detection method or boundary tracing method and is more preferably done by an inner boundary tracing method.

If the conversion of the boundary of a finite area defined in a raster graphics to a path is a content extension area of a print job the path may become the content extension path of the print job in a preferred embodiment of the nesting method. If the conversion of the boundary of a finite area defined in a raster graphics to a path is a content area of a print job the path may become the content path of the print job in a preferred embodiment of the nesting method.

A closed path (1402) is a path that has an end 2D-point that has the same coordinates as the start 2D-point. The closed path may be defined as a ordered table of 2D-points (Pₙ) wherein

nε[0,N[

and N is the amount of 2D-points of the closed path. The following 2D-point of a 2D-point (Pₙ) of a closed path is Pₙ₊₁ if n is smaller than N−1 else the following 2D-point is P₀. The previous 2D-point of a 2D-point (Pₐ) of a closed path is Pₙ₋₁ if n is greater than zero else the previous 2D-point is P_{N-1}. A following 2D-point is also called a next 2D-point.

A segment of a path, also called a section of a path, is a path that follows partly the track of a second path. The second path may be a closed path but a segment is not a closed path so it has an end 2D-point which has different coordinates than the start 2D-point. Preferably a segment of a path has a start 2D-point and an end 2D-point that belongs to the sequence of 2D-points of the second path. More preferably the 2D-points of the sequence of the second path belong all to the sequence of 2D-points of the second path. Most preferably the 2D-points of the sequence of the second path belong all to the sequence of 2D-points of the second path and the sub-paths of the segment of the second path are the same as the sub-paths of the second path.

If the path is a closed path (1402) it can be used to define an area. It is meant to be the area inside the closed path and thus the area with the finite surface (1401).

Algorithms to determine the intersection of two areas that are defined by a closed path are known in computer-aided design (CAD) or vector graphic drawing software such as Adobe® Illustrator. The determination of an intersection in a preferred embodiment of the nesting method is preferably done by a surface-to-surface intersection (SSI) method.

A path can be simplified also called smoothed by several algorithms e.g. polynomial approximation or other known approximation theories that are used in mathematics but preferable by reducing the number of 2D-points in the path and more preferably it is done by an iterative end-point fit algorithm to enhance the calculations of e.g. intersection algorithms.

If the 2D-points of a first closed path may form a second closed path with sub-path defined as lines and wherein the second closed path defines an internal area as irregular polygon, the first closed path is called an irregular closed path (FIG. 14, FIG. 15, FIG. 16, FIG. 17, FIG. 18) that defines an irregular area.

If the 2D-points of a first closed path may form a second closed path with sub-path defined as lines and wherein the second closed path defines an internal area as irregular concave polygon, the first closed path is called an irregular concave closed path (FIG. 14, FIG. 15, FIG. 16, FIG. 17, FIG. 18) that defines an irregular concave area. Typical characteristics of irregular polygons are polygons with sides of any length and/or each interior angle can be any measure.

If the 2D-points of a first closed path may form a second closed path with sub-path defined as lines and wherein the second closed path defines an internal area as self intersecting polygon, the first closed path is called an self-intersecting closed path (FIG. 15, FIG. 16) that defines a self-intersecting area else the first closed path is called an non-self-intersecting closed path that defines a non-self-intersecting area.

A preferred embodiment of the nesting method includes a step to detect if a closed path such as content path (CT1, CT2), content extension path (CTE1, CTE2, CTE3, CTE4), minimum content extension path (A_{min,1}) and the maximum content extension path (A_{max,1}) is an irregular closed path and/or a irregular concave closed path and/or a self intersecting closed path (e.g. Shamos-Hoey algorithm, Bentley-Ottmann algorithm). This preferred embodiment may convert a self-intersecting closed path to a non-self intersecting closed path. An self-intersecting closed path may define an area with holes which is called a hole self-intersecting closed path (FIG. 16). A preferred embodiment may convert a hole self-intersecting closed path in a self-intersecting closed path without a hole with preferably a hole removing closed path simplifying method.

The amount of 2D-points in a path define the grade of complexity to calculate areas of closed paths, length of closed paths, intersections and methods used in graph theory or computational geometry: Higher the amount of 2D-points, higher the complexity of calculation and/or higher the time of calculation.

### Iterative End-Point Algorithm

The algorithm reduces the number of 2D-points (FIG. 18). The reducing may be based on how the sub-path is defined such as a line, polygon, a Bezier curve or a parametric equation. Douglas-Peucker algorithm is an example of an iterative end-point algorithm wherein a sub-path is defined as a line. Another example is the Visvalingam algorithm. An iterative end-point algorithm may comprise the following steps:

The starting path is an ordered set of 2D-points and the distance dimension ε>0; and

The algorithm recursively divides the path between the ordered set of 2D-points. Initially it is given all the 2D-points between the start 2D-point and end 2D-point. It automatically marks the start 2D-point and end 2D-point to be kept. It then finds the 2D-point that is furthest from the line with start 2D-point and end 2D-point. If the 2D-point is closer than ε to the line then any points not currently marked to keep can be discarded without the simplified curve being worse than ε. If the point furthest from the line is greater than E from the approximation then that 2D-point must be kept. A new path can be generated consisting of all (and only) those 2D-points that have been marked as kept.

The algorithm may recursively call itself with the start 2D-point and the worst 2D-point and then with the 2D-point and the end 2D-point (which includes marking the worst 2D-point being marked as kept). When the recursion is completed a new path can be generated consisting of all (and only) those 2D-points that have been marked as kept.

The algorithm may replace two 2D-points with another 2D-point to simplify the path.

### Enlarge Surface Optimized Closed Path Simplifying Method

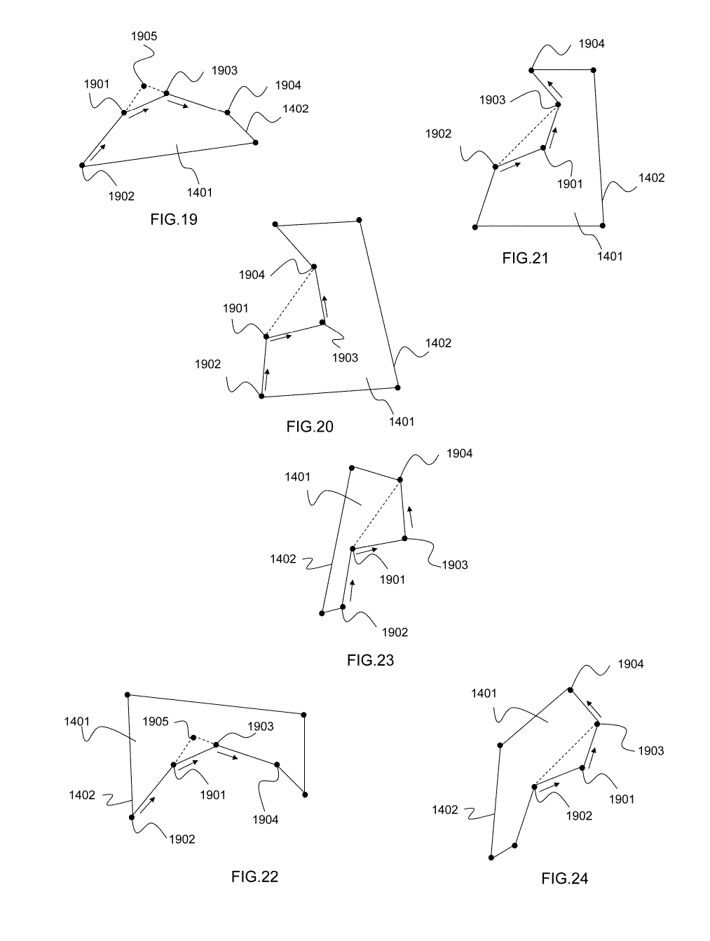

An enlarge surface optimized closed path simplifying method simplifies the closed path but the surface of the area that is inside the closed path (the finite area) may only become equal or larger after simplifying also called smoothing (FIG. 19, FIG. 20, FIG. 21). Preferably polynomial approximation algorithm is used to simplify the closed path and more preferably a method by reducing the amount of 2D-points.

A preferred enlarge surface optimized closed path simplifying method comprises the following steps:

a) order the 2D-points (Pₙ) of the closed path so the finite area of the closed path is left (counter-clock wise ordering or CCWO) or right positioned (clock wise ordering or CWO) against the 2D-points of the closed path;

b) calculate for each 2D-points (Pₙ) of the closed path the turn of the line with the 2D-point as start point (Pₙ) (1901) and the following 2D-point (Pₙ₊₁) (1903) as end-point against the line with the previous 2D-point as start point (Pₙ₋₁) (1902) and the 2D-point (Pₙ) (1901) as end-point. The calculation of the turn may be achieved by calculating the angle at the side of the finite area of the closed path that is formed by the line with the previous 2D-point as start point (Pₙ₋₁) and the 2D-point (Pₙ) as end-point and the line with the 2D-point as start point (Pₙ) and the following 2D-point (Pₙ₊₁) as end-point. If the angle is smaller than or equal than 180 degrees the 2D-point (Pₙ) is called a compliant 2D-point of the closed path which makes a compliant turn, else the 2D-point (Pₙ) is called a noncompliant 2D-point of the closed path which makes a noncompliant turn;

c) select a 2D-point (Pₙ) of the closed path;

d) if the selected 2D-point (Pₙ) (1901) and the following 2D-point (Pₙ₊₁) (1903) are compliant 2D-points, the intersection of the line between the previous 2D-point (Pₙ₋₁) (1902) and the selected 2D-point (Pₙ) (1901) and the line between the following 2D-point (Pₙ₊₁) (1903) and the following of the following 2D-point (Pₙ₊₂) (1904) is calculated and than added to the closed path while the selected 2D-point (Pₙ) (1901) and the following 2D-point (Pₙ₊₁) (1903) is removed from the closed path (FIG. 19);

e) if the selected 2D-point (Pₙ) (1901) is a compliant 2D-point and the following 2D-point (Pₙ₊₁) is a noncompliant 2D-point, the following 2D-point (Pₙ₊₁) is removed from the closed path (FIG. 20);

f) if the selected 2D-point (Pₙ) (1901) is a noncompliant 2D-point, the selected 2D-point (Pₙ) (1901) is removed from the closed path (FIG. 21).

The closed path with a different set of 2D-points after performing this previous preferred embodiment shall remain ordered and the method may be repeated starting at step b). This preferred enlarge surface optimized closed path simplifying method reduces the amount of 2D-points in a closed path and enlarges the finite area that is defined by the closed path.

A preferred embodiment of the preferred enlarge surface optimized closed path simplifying method may comprising a method of selecting optimal 2D-point in step c) by calculating in step b) each surface (Tₙ) for each 2D-point of the closed path that is formed by the line with the previous 2D-point as start point (Pₙ₋₁) (1902) and the 2D-point (Pₙ) (1901) as end-point and the line with the 2D-point as start point (Pₙ) and the following 2D-point (Pₙ₊₁) (1903) as end-point (the area is thus a triangle, and also called the triangle-area of a 2D-point in a path which may be closed path) and by selecting in step c) a 2D-point where the triangle-area is the minimum of all the other triangle-areas of the 2D-points of the closed path.

### Shrink Surface Optimized Closed Path Simplifying Method

A shrink surface optimized closed path simplifying method simplify the closed path but the surface of the area that is inside the closed path (the finite area) may only become equal or smaller after simplifying also called simplifying (FIG. 22, FIG. 23, FIG. 24). Simplifying is also called simplifying. Preferably polynomial approximation algorithm is used to simplify the closed path and more preferably a method by reducing the amount of 2D-points.

A preferred shrink surface optimized closed path simplifying method comprises the following steps:

a) order the 2D-points (Pₙ) of the closed path so the finite area of the closed path is left (counter-clock wise ordering or CCWO) or right positioned (clock wise ordering or CWO) against the 2D-points of the closed path;

b) calculate for each 2D-points (Pₙ) of the closed path the turn of the line with the 2D-point as start point (Pₙ) (1901) and the following 2D-point (Pₙ₊₁) (1903) as end-point against the line with the previous 2D-point as start point (Pₙ₋₁) (1902) and the 2D-point (Pₙ) (1901) as end-point. The calculation of the turn may be achieved by calculating the angle at the side of the finite area of the closed path that is formed by the line with the previous 2D-point as start point (Pₙ₋₁) and the 2D-point (Pₙ) as end-point and the line with the 2D-point as start point (Pₙ) and the following 2D-point (Pₙ₊₁) as end-point. If the angle is smaller than or equal than 180 degrees the 2D-point (Pₙ) is called a compliant 2D-point of the closed path which makes a compliant turn, else the 2D-point (Pₙ) is called a noncompliant 2D-point of the closed path which makes a noncompliant turn;

c) select a 2D-point (Pₙ) of the closed path;

d) if the selected 2D-point (Pₙ) (1901) and the following 2D-point (Pₙ₊₁) (1903) are noncompliant 2D-points, the intersection of the line between the previous 2D-point (Pₙ₋₁) (1902) and the selected 2D-point (Pₙ) and the line between the following 2D-point (Pₙ₊₁) and the following of the following 2D-point (Pₙ₊₂) (1904) is calculated and than added to the closed path while the selected 2D-point (Pₙ) (1901) and the following 2D-point (Pₙ₊₁) (1903) is removed from the closed path (FIG. 22);

e) if the selected 2D-point (Pₙ) (1901) is a noncompliant 2D-point and the following 2D-point (Pₙ₊₁) (1903) is a compliant 2D-point, the following 2D-point (Pₙ₊₁) is removed from the closed path (FIG. 23);

f) if the selected 2D-point (Pₙ) (1901) is a compliant 2D-point, the selected 2D-point (Pₙ) is removed from the closed path (FIG. 24).

The closed path with a different set of 2D-points after performing this previous preferred embodiment shall remain ordered and the method may be repeated starting at step b). This preferred shrink surface optimized closed path simplifying method reduces the amount of 2D-points in a closed path and shrinks the finite area that is defined by the closed path.

A preferred embodiment of the preferred shrink surface optimized closed path simplifying method may comprising a method of selecting optimal 2D-point in step c) by calculating in step b) each surface (Tₙ) for each 2D-point of the closed path that is formed by the line with the previous 2D-point as start point (Pₙ₋₁) (1902) and the 2D-point (Pₙ) (1901) as end-point and the line with the 2D-point as start point (Pₙ) (1901) and the following 2D-point (Pₙ₊₁) (1903) as end-point (the area is thus a triangle, and also called the triangle-area of a 2D-point in a path which may be closed path) and by selecting in step c) a 2D-point where the triangle-area is the minimum of all the other triangle-areas of the 2D-points of the closed path.

### Hole Removing Closed Path Simplifying Method

A hole removing closed path simplifying method simplifies a hole self-intersecting closed path (FIG. 16) so a hole is removed in the finite area that is defined by the closed path.

A preferred hole removing closed path simplifying method comprises the following steps:

a) order the 2D-points (Pn) of the closed path so the finite area of the closed path is left (counter-clock wise ordering or CCWO) or right positioned (clock wise ordering or CWO) against the 2D-points of the closed path;

b) calculate for each 2D-points (Pn) of the closed path the turn of the line with the 2D-point as start point (Pn) and the following 2D-point (Pn+1) as end-point against the line with the previous 2D-point as start point (Pn−1) and the 2D-point (Pn) as end-point. The calculation of the turn may be achieved by calculating the angle at the side of the finite area of the closed path that is formed by the line with the previous 2D-point as start point (Pn−1) and the 2D-point (Pn) as end-point and the line with the 2D-point as start point (Pn) and the following 2D-point (Pn+1) as end-point. If the angle is smaller than or equal than 180 degrees the 2D-point (Pn) is called a compliant 2D-point of the closed path which makes a compliant turn, else the 2D-point (Pn) is called a noncompliant 2D-point of the closed path which makes a noncompliant turn;

c) select a 2D-point (Pn) of the closed path which causes a hole in the finite area of the closed path;

d) if the selected 2D-point (Pn) and the following 2D-point (Pn+1) are noncompliant 2D-points, the intersection of the line between the previous 2D-point (Pn−1) and the selected 2D-point (Pn) and the line between the following 2D-point (Pn+1) and the following of the following 2D-point (Pn+2) is calculated and than added to the closed path while the selected 2D-point (Pn) and the following 2D-point (Pn+1) is removed from the closed path.

e) if the selected 2D-point (Pn) is a noncompliant 2D-point and the following 2D-point (Pn+1) is a compliant 2D-point, the following 2D-point (Pn+1) is removed from the closed path;

f) if the selected 2D-point (Pn) is a compliant 2D-point, the selected 2D-point (Pn) is removed from the closed path.

The closed path with a different set of 2D-points after performing this previous preferred embodiment shall remain ordered and the method may be repeated starting at step b). This preferred hole removing closed path simplifying method reduces the amount of 2D-points in a closed path and removes holes the finite area that is defined by the closed path.

### Segment Creator

In a preferred embodiment of the nesting method while determining a third content extension path and a fourth extension path a segment (60) of the third content extension path is in common with a part of the fourth content extension path and the segment (60) is part of the first intersection area (J) (50). So the segment (60) is a segment (60) of the third content extension path and is also a segment (60) of the fourth extension path. A more preferred embodiment of the nesting method is characterized that the segment (60) has a start point that is in common with the minimum content extension path of the first print job and the maximum content extension path of the first print job and/or the segment (60) has an end point that is in common with the minimum content extension path of the first print job. The calculation of the segment (60) is done by a segment (60) creator which may be comprised in the processing apparatus (82) that performs the nesting method. (FIG. 27, FIG. 28, FIG. 29)

A preferred embodiment of the nesting method to calculate the segment (60) comprises the following steps:

calculate the minimum content extension path of the first print job, which is the path you would get when the content extension area of the second print job overlaps the content extension area of the first print job;

calculate the maximum content extension path of the first print job, which is the path you would get when the content extension area of the first print job overlaps these content extension area of the second print job;

isolate a section from the minimum content extension path (2704) and a section from the maximum content extension path (2708) where the paths don't overlap. Both sections must start and end with a 2D-point that is part of the minimum content extension path and the maximum content extension path (2701, 2702).

draw a straight line from the start 2D-point of the section to the end 2D-point of the section to create a new path. This new path is a first (very rough) approximation of the segment (2709) we want to achieve in a preferred embodiment wherein the segment creator is comprised.

The approximation of the segment (2709) in a preferred embodiment is to achieve a segment so that the ratio R1 is from 90% until 110% and R2 is larger than 5% and smaller than 95% or more preferred R1 is in the range from 95% until 105% and most preferred in the range of 95% until 99.99%. Another preferred embodiment is to improve the approximation of the segment so that the ratio R1 is from 90% until 110% and R2 is larger than 25% and smaller than 75%, more preferably R2 is larger than 40% and smaller than 60% and most preferably R2 is larger than 45% and smaller than 55%.

A preferred embodiment of the approximation of the segment comprises the following steps:

recursively (FIG. 27, FIG. 28, FIG. 29) improve the approximation comprising the following steps:

a) check each sub-path of the current segment;

b) if the length of a sub-path of the current segment is smaller than a calculated or pre-defined threshold, no further approximation between the 2D-points of the sub-path is calculated;

c) else draw a line at the middle of the sub-path perpendicular to the line between the 2D-points of the current sub-path (2709);

d) find all the 2D-points where the perpendicular line intersect the minimum content extension path (2706); and select one of these intersection 2D-points

e) find all the 2D-points where the perpendicular line intersect the maximum content extension path (2707); and select one of these intersection 2D-points;

f) add a new 2D-point between the start 2D-point and the end 2D-point of the sub-path in the middle of the selected intersection 2D-points;

g) continue the approximation with the step defined in a).

Preferably the predefined threshold in a preferred embodiment of the nesting method with the approximation of the segment is smaller than 10 cm, more preferably smaller than 1 cm and most preferably smaller than 5 mm.

Another preferred embodiment of the nesting method with the approximation of the segment is that the predefined threshold is smaller than the average of the lengths of the sub-path of the minimum content extension path and/or the lengths of the sub-path of the maximum content extension path and is more preferred smaller than the minimal length of the sub-path of the minimum content extension path and/or the minimal length of the sub-path of the maximum content extension path.

Preferably the calculated threshold in a preferred embodiment of the nesting method with the approximation of the segment is smaller than 20% of the length of the line between the start 2D-point and the end 2D-point of the segment, more preferably the calculated threshold is smaller than 10% of the length of the line between the start 2D-point and the end 2D-point of the segment and most preferably the calculated threshold is smaller than 5% of the length of the line between the start 2D-point and the end 2D-point of the segment.

Another preferred embodiment of the nesting method, wherein the segment creator is comprised, comprises a step combines the created segment and the segment that is not part of the isolated section of the minimum content extension path of the first print job to a new path that defines the third content extension path which defines the third content extension area.

Another preferred embodiment of the nesting method, wherein the segment creator is comprised comprises a step that combines the created segment and the segment that is not part of the isolated section of the maximum content extension path of the first print job to a new path that defines the fourth content extension path which defines the fourth content extension area.

### Rastering

Sometimes vector graphics needs to be converted to raster graphics. The method of converting is called rastering. Rastering depends on a needed resolution and colour space. Also the visualization on a computer screen of content in a portable document format, which uses vector graphics, is using rastering methods. The raster graphics have than a plurality of rastered pixels.

It have to be understood that the nesting of print jobs on one or more sheets of substrate or on a roll of substrate as disclosed in a preferred embodiment of the nesting method is nesting the content of to be nested print jobs on a fictitious canvas that digitally represents the sheet or roll whereon shall be nested. After the nesting of the selected print jobs several approaches can be achieved to render (=to raster and to send) the nested print jobs to a digital printing system. The rendering of the nested print jobs simultaneously is also calling multiplexing of the nested print jobs. Examples of state-of-the-art for rendering multiple print jobs on a sheet or roll are disclosed in EP 2455184 A (AGFA GRAPHICS N.V.) wherein a method of printing is disclosed which multiplexes more than one print jobs on a substrate into logical print zones for reducing the waste of unprinted substrate.

In a preferred embodiment of the nesting method, if the content area is defined by vector graphics or page description language, a preferred embodiment of the nesting method may raster the vector graphics or page description language to a bitmap format near and/or at the boundary of the content area and the area of the content extension area that is not part of the content area may be filled with the rastered content data at the boundary of the content area. It is preferable that the rastering comprises also a method of colour conversion, also called colour management, that no colour difference can be seen after printing of the print job between the boundary of the content area and the content extension area that is not part of the content area. This may achieved by rastering to a known colour space such as sRGB, wide-gamut RGB colour space e.g. from Adobe or to a device-independent colour space such as CIEXYZ or CIELab, created by the International Commission on Illumination (CIE). When the nested print jobs shall be rasterized the content extension area that is no part of the content area may be rastered from the known colour space or device-independent colour space to the colour space of the digital printer.

### Nesting

A preferred embodiment of the nesting method (82) and preferred embodiments of the nesting method may comprising the following steps:

ordering print jobs based on nesting priorities that where given as input while selecting print jobs in the nesting queue in a preferred embodiment of the nesting method; and/or

visualizing statistics of the nesting performance e.g. how much free space is still available on the sheet; and/or

grouping a part of print jobs together on a part of a sheet because they have to be finished together; and/or

grouping all print jobs together on a part of a sheet so the unused part of the sheet has a maximum surface. The unused part of the sheet can be reused after finishing the nested print jobs; and/or

scaling of a print job preferably with a scale factor from 95% until 100% and more preferably with a scale factor from 97% until 99.99% to optimize the nesting and thus reducing the substrate waste; and/or

calculating the minimal distance and/or maximal distance between the content area and/or bleed are of two nested print jobs; and/or

using a defined minimum interspace distance, also called margins while nesting print jobs so the minimal distance between the content area or content extension area of print jobs is equal or larger than the defined minimum interspace distance; and/or

avoiding nesting in a certain area on a sheet wherein no print jobs may be nested e.g. when the substrate is already pre-printed with an image; and/or

nesting of print jobs on the front and the back of a sheet to print double-side prints; and/or

visualizing the content paths and/or content extension paths by a colored line; and/or

visualizing the content paths and/or content extension paths by a colored line or colored area.

The use of a minimum interspace distance, also called margin is needed for several reasons:
When using a milling tool (rotary cutter) and the print jobs are too close to each other. Then there might not be enough material left of the substrate to ensure proper vacuum fixation on the table of the digital table cutting table. Also the substrate may loose rigidity and may deform or move during the cutting.
A milling tool usually have a vacuum cleaner attached in order to get rid of the debris; but when print jobs themselves are small, cutting out one print job may suck in its already cut loose neighboured nested print jobs.
To create space to add registration dots on the sheet of substrates.

The arrangement of print jobs on a sheet, in a preferred embodiment of the nesting method may be done manually.

The nesting method may provide a visualization method wherein the operator may arrange a print job on a sheet by e.g. adding, rotating, multiplying, removing. The print jobs are preferable visualized by thumbnails of the content of the print jobs.

A preferred embodiment of the nesting method may provide a method to give about possible overlap of content areas of different print jobs.

Preferably the manual arrangement of print jobs on a sheet is based on grid snapping which allows a print job to be easily positioned in alignment with grid lines, guide lines or another object, by causing it to automatically jump to an exact position when the user drags it to the proximity of the desired location.

A more preferred embodiment of the nesting method is to arrange the print jobs on a sheet automatic to reduce the waste of a substrate and to shorten the production time. The automatic arrangement may be based on the shape and/or dimension of the content extension area and the size of the sheet but preferably it is based on the shape and/or dimension of the content area and the size of the sheet to reduce more the waste of a substrate and to shorten the production time. The automatic arrangement may be rectangular nesting but it is more preferably automatic arranged by true shape nesting.

Preferably the nesting method with automatic arrangement orders the print jobs based on the surface of the content area or content extension area before filling the sheet.

Preferably the nesting method with automatic arrangement may rotate the print jobs to optimize the reducing of waste. To minimize the calculation of nesting it is preferred to rotate the print job in incremental steps while trying to fit a print job on a sheet.

### Rectangular Nesting

The method of rectangular nesting uses a rectangle around the shape of the content area or content extension area a print job with largest height and width. The shape of the content area or content extension area of the print job is than treated as the geometry of the rectangle and not the real shape of the content area and/or content extension area of the print job when placing the print job on the sheet while nesting. This method is a fast nesting method and reduces the waste of a substrate.

### True Shape Nesting

The method of true shape nesting identifies a portion of the actual shape of the content area or content extension area of a print job. E.g. the left side and bottom of the actual shape of the content area or content extension area of a print job is examined to determine how well it fits with adjacent shape of content area's or content extension area's of other print jobs. The top and the right side of the actual shape of the content area or content extension area of a print job are ignored until another print job is placed next to it.

Preferably while using true shape nesting is comprised in the embodiment of the nesting method, the print jobs that are already placed on the sheet remain stationary and only newly print jobs are considered for arrangement and rotation. The purpose of this heuristic rule is to eliminate most of the calculation of nesting. This heuristic rule is sometimes called “first fit”.

The true shape nesting may comprising the following steps:

a) Order the print jobs from largest to smallest surface of content area or content extension area; and

b) Place the largest print job on the sheet; and

c) Rotate the print job to the orientation that brings it closest to a corner of the sheet, also called the nesting corner; and

d) Place the next largest print job on the sheet; and

e) Rotate the print job to the orientation that brings it closest to the nesting corner; and

f) Repeat steps d) and e) until all print jobs are nested or until no more print jobs will fit on the sheet.

Preferably while using true shape nesting is comprised in a preferred embodiment of the nesting method, the nesting method takes the whole shape of the content area or content extension area of a print job into account while optimal filling a sheet and preferably multiple print jobs are observed to fill a sheet without a time consuming trial and error process of rotating print jobs in hundreds of small increments to check for a fit.

Another preferred method of true shape nesting is a neighbourhood search nesting method. An example of a neighbourhood search nesting method is disclosed in “Fast Neighborhood Search for the Nesting Problem” by BENNY KJAER NIELSEN et al, in Technical Report 03/03, Department of Computer Science, University of Copenhagen and this preferred method of true shape nesting is optimized with method to solve the traveling salesman problem (TSP) such as Guided Local Search (GLS) and Fast Local Search FLS). Theory and methodology about these guided local search and fast local search and the traveling salesman problem is disclosed in “Guided local search and its application to the travelling salesman problem” by CHRISTOS VOUDOURIS et al, in European Journal of Operational Research 113 (1999) p 469-499.

True shape nesting may nest a group of print jobs that have a best fit together by the shape of their content area's or content extension area's independently of the sheet whereon is nested and than nest this group of print jobs with the other print jobs.

### OTHER DEFINITIONS

The formula (I) that defines the first intersection area (J) (50) can also be written as

J=((CTE1\CTE2)∪CT1)∩((CTE1\CT2)∪CT1)

The intersection J3 of the third content extension area (CTE3) (31) and the first intersection area (J) (50) is also defined by formula (IV):

J3=CTE3∩J

The intersection J4 of the fourth content extension area (CTE4) (41) and the first intersection area (J) (50) is also defined by formula (V):

J4=CTE4∩J

The area K1 of the third content extension area (CTE3) (31) that is not part of the first content extension area (CTE1) (11) is defined by formula (VI):

K1=CTE3\CTE1

The area K2 of the fourth content extension area (CTE4) (41) that is not part of the second content extension area (CTE2) (21) is defined by formula (VII):

K2=CTE4\CTE2

Formula (VI) that defines the third content extension area (CTE3) (31) that is not part of the first content extension area (CTE1) (11) can also be written as

K1=CTE3−CTE1

Formula (VII) that defines the fourth content extension area (CTE4) (41) that is not part of the second content extension area (CTE2) (21) can also be written as

K2=CTE4−CTE2

The minimum content extension path of the first print job is defined by the area A_{min,1} that is defined by formula (VIII):

A_{min,1}=CTE1−CTE2+CT1

The maximum content extension path of the first print job is defined by the area A_{max,1} that is defined by formula (IX):

A_{max,1}=CTE1−CT2+CT1

The formula (VIII) that defines the area A_{min,1} of minimum content extension path can also be written as:

A_{min,1}=((CTE1\CTE2)∪CT1)

The formula (IX) that defines the area A_{max,1} of minimum content extension path can also be written as:

A_{max,1}=((CTE1\CTE2)∪CT1)

The area L1 of the first content extension area (CTE1) (11) that is not part of the third content extension area (CTE3) (31) is defined by formula (X):

L1=CTE1\CTE3

The area L2 of the second content extension area (CTE2) (21) that is not part of the fourth content extension area (CTE4) (41) is defined by formula (XI):

L2=CTE2\CTE4

Formula (X) that defines the first content extension area (CTE1) (11) that is not part of the third content extension area (CTE3) (31) can also be written as

L1=CTE1−CTE3

Formula (XI) that defines the second content extension area (CTE2) (21) that is not part of the second content extension area (CTE4) can also be written as

L2=CTE2−CTE4

### Other Preferred Embodiments

A preferred embodiment of the nesting method is that nesting of print jobs is not only done on 1 sheet of substrate but also on a plurality of sheets of substrates to enhance the production timings of printing jobs even more.

Another preferred embodiment of the nesting method is the use of templates that pre-defines the position of the printing jobs to enhance the production timings of printing jobs.

Another preferred embodiment of the nesting method is the optimization of the waste and minimal extra cuttings to a part of the substrate waste that still can be used to be printed and/or nested of print jobs on. An economical benefit can be gained by this preferred embodiment when the price of a substrate is high.

Another preferred embodiment of the nesting method is the adds of marks e.g. control-strips, registration-marks, camera registration-marks, cutting lines, cut-marks, indication marks such as QR-codes and barcodes while nesting the print jobs. It can enhance the quality control of the finished products.

Enlarge surface optimized closed path simplifying method as separate preferred embodiment

### INDUSTRIAL APPLICABILITY

By replacing partial overlapping content extension areas, nesting methods can improve the reducing of substrate waste and enhancing the productivity of print jobs.

### REFERENCE SIGNS LIST

90,91,92: print jobs
11, 21, 901.2502: content extension area
12, 22, 902, 2501: content area
2503: content path
2504: content extension path
81: nesting queue
82: processing apparatus that performs a nesting method
830: rectangular nested print jobs
831: true-shape nested print jobs
50: intersection area of 2 content extension areas
111: minimum content extension area of left print job
112: maximum content extension area of left print job
60, 2701: segment
31: replaced content extension area of left print job
41: replaced content extension area of right print job
1201, 1202, 1203: three-dimensional object manufactured by printed, finished print jobs on card-board
1302: manufacturing (folding) a three-dimensional object from a finished print job on card-board
1303: a print job that may be folded to a three-dimensional object wherein the lock flaps and foot are content extension areas.
1401: finite area of a closed path
1402: a closed path
1501: a self-intersection of a self-intersection closed path
1601: a hole in a hole self-intersection closed path
1901: a 2D-point in a closed path
1902: previous 2D-point in a closed path of a 2D-point (1901) in a closed path
1903: following 2D-point in a closed path of a 2D-point (1901) in a closed path
1904: following 2D-point in a closed path of a following 2D-point (1903) of a 2D-point (1901) in a closed path
1905: an added 2D-point after converting a closed path with an iterative end-point algorithm.
2701: start 2D-point of a segment
2702: end 2D-point of a segment
2704: an isolated section of a minimum content extension path
2708: an isolated section of a maximum content extension path
2705: intersection area of two content extension areas of a print job
2706: intersection of a perpendicular line and isolated section of a minimum content extension path
2707: intersection of a perpendicular line and isolated section of a maximum content extension path
2709: a perpendicular line

1-15. (canceled)

16. A nesting method comprising:
obtaining a first print job and a second print job, wherein the first print job includes a first content area defined by a first content path and a first content extension area, which is defined by a first content extension path, and the second print job includes a second content area defined by a second content path and a second content extension area, which is defined by a second content extension path, and the first content extension area partially overlaps with the second content extension area;
determining a first intersection area; and
replacing the first content extension area with a third content extension area, and replacing the second content extension area with a fourth content extension area;
wherein
A is a surface of the first intersection area;
B is a surface of an overlap of the third content extension area and the first intersection area;
C is a surface of an overlap of the fourth content extension area and the first intersection area;
J is defined by a Formula (I):
J=((CTE1\CTE2)∪CT1)∩((CTE1\CT2)∪CT1)
a ratio R1 is defined by a Formula (II):
$$R 1 = \frac{A}{B + C}$$
a ratio R2 is defined by a Formula (III):
$$R 2 = \frac{B}{A}$$
the ratio R1 is from 90% to 110%; and
the ratio R2 is larger than 5% and smaller than 95%.

17. The method according to claim 16, further comprising the steps of:
determining a third content extension path that defines the third content extension area; and
determining a fourth content extension path that defines the fourth content extension area; wherein
the step of replacing the first content extension area with the third content extension area, and the step of replacing the second content extension area with the fourth content extension area are performed such that:
a segment of the third content extension path is in common with a portion of the fourth content extension path; and
the segment is a portion of the first intersection area.

18. The method according to claim 17, further comprising the steps of:
determining a minimum content extension path of the first print job that defines an area from the first content extension area minus the second content extension area plus the first content area; and
determining a maximum content extension path of the first print job that defines an area from a sum of the first content extension area minus the second content area plus the first content area; wherein
the step of replacing the first content extension area with the third content extension area, and the step of replacing the second content extension area with the fourth content extension area are performed such that:
the segment includes a start point that is in common with the minimum content extension path of the first print job and the maximum content extension path of the first print job; and/or
the segment includes an end point that is in common with the minimum content extension path of the first print job and the maximum content extension path of the first print job.

19. The method according to claim 18, further comprising the step of:
simplifying one of the first content extension path and the second content extension path.

20. The method according to claim 19, wherein the step of simplifying includes a hole removing closed path simplifying method.

21. The method according to claim 19, wherein the step of simplifying includes an enlarge surface optimized closed path simplifying method.

22. The method according to the claim 18, wherein rasterized pixels of the first print job positioned on the first content path are cloned in an area that is defined by the first content extension area minus the first content area.

23. A true shape nesting method comprising:
a method of nesting according to claim 18.

24. A processing apparatus which executes a nesting process on a first print job and a second print job wherein the first print job includes a first content area defined by a first content path and a first content extension area, which is defined by a first content extension path, and the second print job includes a second content area defined by a second content path and a second content extension area, which is defined by a second content extension path, and the first content extension area partially overlaps with the second content extension area, the processing apparatus comprising:
a first determination means that determines a first intersection area; and
a content extension area replacer that replaces the first content extension area with a third content extension area, and that replaces the second content extension area with a fourth content extension area; wherein
A is a surface of the first intersection area;
B is a surface of an intersection of the third content extension area and the first intersection area;
C is a surface of an intersection of the fourth content extension area and the first intersection area;
J is defined by a Formula (I):
J=((CTE1\CTE2)∪CT1)∩((CTE1\CT2)∪CT1)
R1 is defined by a Formula (II):
$$R 1 = \frac{A}{B + C}$$
R2 is defined by a Formula (III):
$$R 2 = \frac{B}{A}$$
the ratio R1 is from 90% to 110%; and
the ratio R2 is larger than 5% and smaller than 95%.

25. The processing apparatus according to claim 24, further comprising:
a second determination means that determines a third content extension path that defines the third content extension area, and that determines a fourth content extension path that defines the fourth content extension area; wherein
the third content extension path has a structure such that:
a segment of the third content extension path is in common with a portion of the fourth content extension path; and
the segment is a portion of the first intersection area.

26. The processing apparatus according to claim 25, further comprising:
a third determination means that determines a minimum content extension path of the first print job that defines an area from the first content extension area minus the second content extension area plus the first content area, and that determines a maximum content extension path of the first print job that determines the maximum content extension path of the first print job that defines an area from the first content extension area minus the second content area plus the first content area; wherein
the segment has a structure such that:
the segment includes a start point that is in common with the minimum content extension path of the first print job and the maximum content extension path of the first print job; and/or
the segment includes an end point that is in common with the minimum content extension path of the first print job and the maximum content extension path of the first print job.

27. The processing apparatus according to claim 26, further comprising:
means that simplify one of the first content extension path and the second content extension path.

28. The processing apparatus according to claim 26, wherein R1 is from 95% to 105%.

29. The processing apparatus according claim 26, further comprising:
a pixel cloner that clones rasterized pixels of the first print job positioned on the first content path in an area that is defined by the first content extension area minus the first content area.

30. A true shape nesting apparatus comprising:
a processing apparatus according to claim 26.
